(19) United States
(12) Patent Application Publication
(10) Pub. No.: US 2019/0391826 A1
(43) Pub. Date: Dec. 26, 2019

(54) NETWORK METHOD AND APPARATUS

(71) Applicant: JUST EAT HOLDING LIMITED, Hertfordshire (GB)

(72) Inventor: Craig PUGSLEY, Hertfordshire (GB)

(21) Appl. No.: 16/481,391

(22) PCT Filed: Jan. 26, 2018
(86) PCT No.: PCT/GB2018/050235

§ 371 Date: Jul. 26, 2019

(30) Foreign Application Priority Data
Jan. 26, 2017 (GB) 1701333.5
Mar. 1, 2017 (GB) 1703329.1

(51) Int. Cl. G06F 9/451; H04W 12/08; G06Q 30/06

(52) U.S. Cl. CPC G06F 9/451; G06Q 30/0641; H04W 12/08

(57) ABSTRACT

A method of operating a computer network comprising a communications device (10) adapted to communicate over a short range communication interface (104) with a plurality of user equipment (UE) (devices 103a,103b,103c) and to communicate with a server (106) over a wide area communication (interface 105). The method comprises obtaining, from the server 06, resource identification data; providing a command to the UEs (103a,103b,103c) to cause the UEs (103a,103b,103c) to obtain, from the (server 106), a list associated with the resource identification data; receiving request data from the UEs (103a,103b,103c) indicating items requested from the list; combining the request data. Also, in response to a first confirmation message, providing the combined request data to a selected UE; and obtaining, from the selected UE, an update identifier and sending a trigger message comprising the update identifier to the server (106) to cause the server (106) to send a series of update messages to the communications (device 101).

### FIELD OF THE INVENTION

The present invention relates to methods and apparatus for network communications and more particularly to reducing network traffic associated with remote monitoring of service provision.

### BACKGROUND

The proliferation of devices such as tablet computers and smartphones, which are now used by many people in their daily lives, has led to an increase in Bring Your Own Device (BYOD) environments in recent years. In these environments network users can bring their own electronic devices into a workplace or other shared location and connect to a network. Simultaneously there has been a sharp increase in the use of cloud computing services, in which end users can store and access data and programs over the internet rather than doing so locally at their devices. For example, Software as a Service (SaaS) is a cloud-based software distribution model in which a third-party provider hosts applications and makes them available to users over the internet. These cloud application services can be used by organisations to deliver applications over the internet that are managed by the third-party and whose interface is accessed on the end user's side. This enables applications and data to be accessible from any connected user device.

Such applications may include a shared resource that is accessed by multiple devices on a local network. These shared resources may comprise computer data, information, or hardware devices that can be easily accessed from a remote computer through a local area network (LAN). Successful shared resource access allows users to operate as if the shared resource were on their own computer.

There are situations that arise when several users in the same geographic area or on the same local network wish to access the same resource or service over the internet. When multiple devices on a local network attempt to access software stored on the same server simultaneously or over a short time period, network load increases which can create an unnecessarily large burden on both the network infrastructure and the data processing capabilities at the server.

### SUMMARY

Aspects and embodiments of the invention are set out in the claims, and may be useful in so called E-commerce platforms in which they aim to address technical problems related to those explained above.

Embodiments relate to the transmission of data from a plurality of user equipment in a local area network to a server over a wide area network.

In an aspect there is provided a method of operating a computer network comprising a communications device adapted to communicate over a short range communication interface with a plurality of user equipment (UE) devices and to communicate with a server over a wide area communication interface,

the method comprising:
obtaining, from the server, resource identification data;
providing a command to the UEs to cause the UEs to obtain, from the server, a list associated with the resource identification data;
receiving request data from the UEs indicating items requested from the selected list;
combining the request data;
and, in response to a first confirmation message, providing the combined request data to a selected UE; and
obtaining, from the selected UE, an update identifier and sending a trigger message comprising the update identifier to the server to cause the server to send a series of update messages to the communications device.

The communications device may respond to the update messages by sending notifications to the UEs over the short range communication interface and/or by an audible or visible alert.

In an embodiment the communications device is configured to respond to request data received from a first one of the UEs by providing a notification message to at least one other of the UEs. The notification message may comprise list item identifier data obtained from the request data received from the first one of the UEs.

In an embodiment the command is configured to cause the UEs to provide a user interface based on the list, and the notification message is configured to cause the UEs to modify the user interface.

Modifying the user interface may comprise identifying, in the user interface of a second UE, an item specified by the request data from the first one of the UEs. For example, the user interface of the second UE may comprise a selectable menu item associated with the item specified by the request data. Identifying the item may comprise providing an indicator in the selectable menu item. The selectable menu item may comprise a boundary defining a region of the user interface, and the indicator may be provided within the boundary.

Modifying may comprise identifying, in the user interface of the second UE, a user associated with the first one of the UEs. Identifying the user may comprise providing an indication of the user's identity in the selectable menu item, for example within the boundary of that menu item.

Modifying may comprise suggesting a second item based on items identified in the notification message. For example the user interface may comprise a plurality of selectable menu items, and suggesting the second item may comprise at least one of marking the selectable menu item associated with the second item and changing a sequence of the selectable menu items in the user interface. Changing the sequence may comprise advancing the second item in the sequence, for example placing the selectable menu item associated with the second item first in the sequence.

In an embodiment, suggesting the second item may comprise providing an icon associated with the first UE, for example where the icon identifies the user of the first UE, to be displayed in the user interface of the second UE. For example, the icon may be displayed in the user interface of the second UE within the boundary of the selectable menu item associated with the item selected at the first UE.

Modifying may comprise causing a display of a selected section of the list. For example a second UE may determine, based on the notification message identifying a first item selected at the first UE, a group of items associated with the first item and modify its user interface to display selectable menu items associated with this group of items, for example by marking the associated menu items on the user interface, and/or causing the user interface to display that group of items (e.g. by auto scrolling through a selectable list). For example items may be associated with one another if they comprise a shared characteristic. In one embodiment items may be associated with one another if they have previously been selected together. In one embodiment, the UEs may store data associating one item and another. For example, in response to receiving a notification message, a UE may determine an associated item based on its stored association data and the item indicated in the received notification message. In another embodiment, a notification message may provide the association. For example, a UE may receive a notification message that indicates both an item selected at another UE and one or more items associated with the selected item.

In one embodiment information associating one item with another may be stored at the server and may be provided to the communications device and a UE in response to receiving a request message.

Modifying may comprise removing items from the list. For example the second UE may remove items from a list obtained from the server, based on the notification message identifying an item selected at the first UE. Removing items may comprise preventing selection of selectable menu item(s) associated with the removed items to the user interface. The removed item(s) may comprise the items selected at the first UE.

The communications device may comprise a display interface for controlling a display. For example the display interface may be configured to transmit a display signal via an HDMI cable to the display. The communications device may provide a display reflecting the content of the notification message. For example the display may provide an indication of the aggregated content of all the notification messages which have been sent. In an embodiment the communications device is configured to display an indication of the notification message content, and the user of the first UE, for a selected time period before reverting to a display of the aggregated content.

An item on a list may comprise a type identifier and a numeric value. In an embodiment the communications device receives a numeric limit from a first UE, and provides an indication of the limit to the other UEs. For example the first UE may enable a first user to select the numeric limit on its user interface and transmit data indicating the selected limit to the communication device. This may trigger the communications device to transmit data indicating the selected limit to the other UEs.

In an embodiment, the notification message causes the UEs to modify the user interface at the UEs based on the limit and content of the notification message, for example the notification message may identify an item of the list. For example the limit displayed on the user interface of the UEs may be decremented due to item(s) being selected at a first UE. In an embodiment, the item(s) identified in the notification message may be an item selected at a first UE. The notification message received by the UEs may instruct the UEs to decrement the limit displayed on their user interfaces, for example the limit may decrement by the value of the item selected at the first UE.

The short range communication interface may comprise at least one of a wireless local area network (WLAN) such as a WiFi (RTM) network and a wireless personal area network (WPAN) such as a Bluetooth network. For example the communications device may comprise one or more antennas operable to send and receive data over at least one of a Wifi (RTM) and Bluetooth (RTM) network.

In an embodiment the first confirmation message is received over the short range communication interface. For example the UE transmits the confirmation message from its network interface, and the communications device receives the confirmation message at its network interface. In an embodiment the selected UE is configured to transmit the combined request data to the server via the wide area communications interface. In an embodiment the communications device stores authorisation data identifying at least one of the UEs. For example the communications device may comprise a data storage unit in which a table is stored, comprising a list of UEs, and, associated with each UE, an indicator indicating whether the UE is an authorised UE.

In an embodiment, responding to the first confirmation message comprises checking whether the confirmation message was provided by an authorised UE. For example the communications device may access the table in its data store, identify the UE from which the confirmation message was received, and check the UE's associated indicator to determine if that UE is an authorise UE. In an embodiment the combined request data is only provided in the event that the confirmation message was provided by an authorised UE.

One embodiment comprises requesting additional authorisation data in the event that the confirmation message was provided by an unauthorised UE. For example the communications device may identify an authorised UE in its data store and transmit a message to this authorised UE comprising an instruction to determine whether the unauthorised UE should be authorised. For example an authorised UE may transmit a message to the communications device to enable a previously unauthorised UE to be designated as authorised.

The communication device may provide, to a first UE, identification data identifying the other UEs and receive, from the first UE, an identifier of a second UE. For example the first UE may receive the identification data and display selectable items indicating each of the other UEs on its user interface, so that a user may select whether to authorise one or more of the other UEs. The first UE may transmit data to the communications device to indicate that the second UE is authorised.

In an embodiment the communications device, in response to receiving confirmation message from a UE, transmits a message to the other UEs which causes them to no longer be operable to transmit a confirmation message. For example the other UEs may remove a selectable item that enabled a user to instruct the UE to send a confirmation message from their user interface.

In an embodiment the communications device only transmits the combined request data in the event that the confirmation message was provided by an authorised UE, for example the second UE. For example if, in response to a confirmation request, an unauthorised UE transmits confirmation message in response to confirmation request, an authorised UE can provide a message to the communications device to authorise a previously unauthorised UE so that the communications device is able to provide the combined request data to that (previously unauthorised) UE. Therefore, while the communications device may be configured to only transmit the combined request data to a UE that the communications device designates as authorised, a previously unauthorised UE may become operable to receive the combined request data if it is authorised by an already authorised UE.

In an embodiment the communications device receives, prior to obtaining resource identification data, a signal from a handheld controller. For example the handheld controller may comprise a user interface which enables a user to scroll through a list of resources stored at the communications device and select one. The handheld controller may transmit instructions from the user via an infrared or Bluetooth (RTM) interface to the communications device. The communications device may determine, based on the received signal, which resource identification data to obtain from the server.

In an embodiment, the communications device receives, prior to obtaining resource identification data, data from each of the plurality of UEs indicating a preference for one of the plurality of lists. For example the UEs may provide selectable menu items to their user interfaces indicating a plurality of resources. For example a UE may receive an indication from a user of a preferred one of the resources identified on the user interface. The UEs may transmit the indications to the communications device.

In an embodiment the communications device determines, based on the data received from each UE, which resource identification data to obtain from the server. For example the communications device may determine which resource was indicated by the greatest number of UEs. In an embodiment the communications device may transmit a connection request. For example the communications device may transmit a discovery request using the Bonjour protocol (RTM). In an embodiment the communications device may receive, from a UE in response to a connection request, a connection confirmation message. For example the UE may transmit the connection confirmation message using the Bonjour protocol (RTM).

In an embodiment the communications device may receive, from the UEs, a message indicating that no more request data will be received from that UE. For example the UE may provide a selectable item on their user interface, which, if selected, causes the UE to transmit the message to the communications device. In an embodiment the notification message received by a UE may cause a message to be displayed comprising instructions to transmit request data. For example the notification message may instruct the UE to display a message to a user on its user interface. In an embodiment the communications device may receive, from one of the UEs, a command to remove request data received from the UE from the combined request data. The UE may provide a selectable area on its user interface, for example within the area associated with each item, which if selected by a user instructs the UE to transmit a command to the communications device to remove the request data associated with that item from the list of combined request data.

In an embodiment each item of request data comprises a UE identifier indicating which UE transmitted the item of request data. For example, each UE may have unique identifier data associated with it and when providing request data to a communications device a UE may provide request data comprising an indication of the selected item and the unique identifier.

Combining the request data may comprise determining, for each item of request data, which UE requested the item, based on its associated UE identifier.

Combining the request data may comprise combining the request data into sets of combined request data, wherein each set is associated to one of the UEs. For example, the communications device may separate the received request data into sets, wherein the items in each set comprise the same UE identifier.

In an embodiment the communications device may provide each set of combined request data to its associated UE. For example the combined request data may identify which UE to transmit each set to based on each set's associated UE identifier. In response to receiving a completion message from a UE, the communications device may transmit the combined request data associated with that UE to that UE.

Each UE may be configured to transmit its associated set of combined request data to the server. For example, each UE may, in response to receiving combined request data, provide a selectable item to its user interface, and in response to the user interface item being selected by a user, transmit the set of combined request data to a server.

### BRIEF DESCRIPTION OF DRAWINGS

Some embodiments of the disclosure will now be described, by way of example only, with reference to the accompanying drawings, in which:

FIG. 1 shows a schematic view of a computer network system;

FIG. 2 shows a schematic view of a communications device;

FIG. 3 shows a telecommunications timing diagram illustrating an example of the method;

FIG. 4 illustrates an example of what is shown on a display during the selection of a resource;

FIG. 5 illustrates an example of the interface shown to a user on a UE when selecting items; and

FIG. 6 illustrates an example of what is shown on a display after the selection of items by a plurality of UEs.

In the drawings like reference numerals indicate like elements.

### SPECIFIC DESCRIPTION

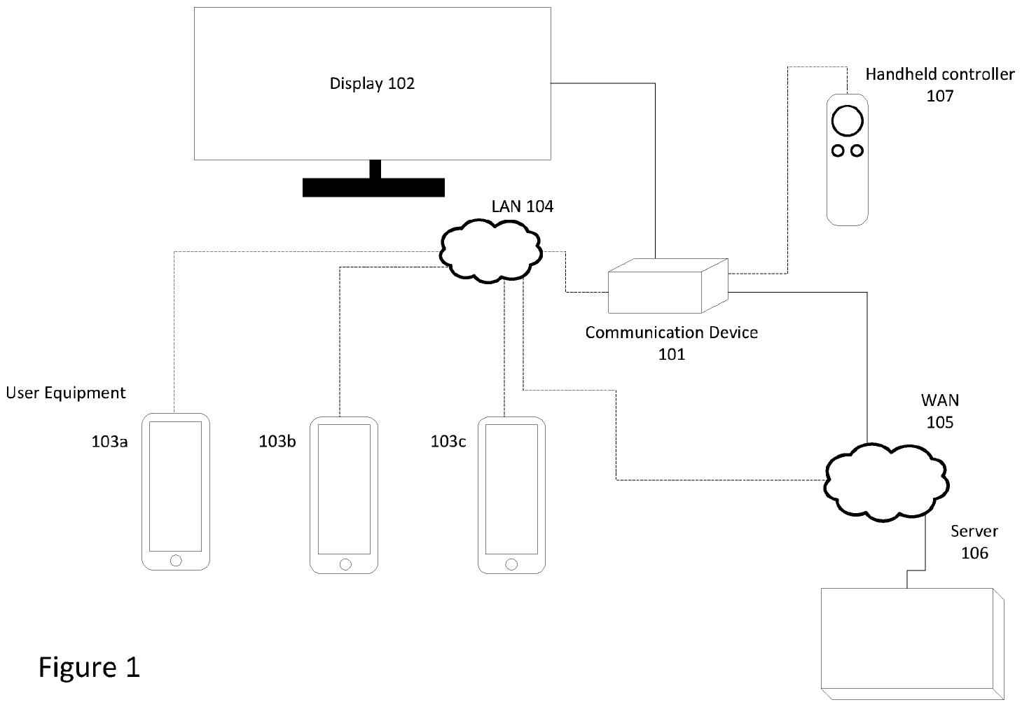

FIG. 1 illustrates a network of apparatus for more efficiently transmitting data from a plurality of user equipment in a local area network to a server over a wide area network. The system comprises a communications device 101, a display 102, a plurality of User Equipment (UEs) 103(a-c) such as smartphones or tablet computers, a Local Area Network (LAN) 104, a Wide Area Network (WAN) 105, a Server 106 and a Handheld Controller 107.

In overview, the system may operate as follows: a resource may be selected at the communications device 102 from a list displayed to a user. The communications device 102 provides a message over the LAN 104 identifying the resource to a plurality of UEs 103. The message comprises a command instructing each UE to obtain a list associated with the selected resource from a server over a wide area network such as the internet. The communications device 102 receives request data from the UEs indicating items from the list that have been chosen at each UE. As the communication device receives each item of request data it combines them into a list of combined request data.

In response to receiving a confirmation message from one of the UEs, the communications device 102 provides the combined request data to that UE. That UE then transmits the combined request data to the server, obtaining a confirmation from the server (e.g. in response to successful completion of an authorisation process) and transmits an update identifier to the communications device to confirm that the request data is being processed at the server. In response, the communications device sends a trigger message to the server over the wide area network, causing the server to send a series of update messages back to it as the request data is processed. This enables the UEs to be updated as to the progress of the processing of request data while reducing load on the network.

The system illustrated in FIG. 1 is now described in detail. The communications device 101 is configured to communicate over a short-range communication interface, for example a WiFi Network such as the LAN 104. It is also configured to communicate over a wide area communication interface, for example the WAN 105. In particular the communications device 101 is operable to communicate with the plurality of UEs 103 over the LAN 104, and is operable to communicate with the server 106 over the WAN 105. The communications device is also operable to control the display 102, for example via an HDMI cable. It is also configured to receive instructions from the handheld controller 107, for example over a Bluetooth or infrared interface.

The UEs 103a-c illustrated in FIG. 1 comprise any UE for communicating over a wide area network 28 and having the necessary data processing capability. They can be a hand-held telephone, a laptop computer equipped with a mobile broadband adapter, a tablet computer, a Bluetooth gateway, a specifically designed electronic communications apparatus, or any other device. It will be appreciated that such devices may be configured to determine their own location, for example using global positioning systems GPS devices and/or based on other methods such as using information from WLAN signals and telecommunications signals. The user device may comprise a computing device, such as a personal computer, or a handheld device such as a mobile (cellular) telephone or tablet. Wearable technology devices may also be used. In FIG. 1, the UEs 103a-c shown are smartphones configured to communicate wirelessly with the LAN 104 and the WAN 105 via a network interface. For example the UEs may connect to the WAN 105 via the LAN 104 as FIG. 1 illustrates. The plurality of UEs 103 are also configured to render a user interface to display information to a user. The user interface is configured such that a user can manipulate it to alter data stored in the UE, for example by using a touch screen. The network interface of the devices described herein may comprise any wired or wireless communication interface such as WI-FI (RTM), Ethernet, or direct broadband internet connection, and/or a GSM, HSDPA, 3GPP, 4G or EDGE communication interface.

The Server 106 stores resource data associated with a plurality of resources. The resources may comprise network locations comprising nodes associated with service provision. Specifically the server stores resource identification data associated with a corresponding one of the resources; and a plurality of lists, wherein each list is associated with each resource. Each list comprises a plurality of items, and each item on the list may have a value associated with it. The server 106 is configured to communicate via WAN 105 with the communications device 101 and the plurality of UEs 103. Specifically the server 106 is operable transmit resource identification data and list data to communications device 101 and UEs 104 in response to request data it receives. Server 106 is also configured to communicate via WAN 105 with the plurality of resources (not shown). The plurality of resources are configured to receive instructions from the server and process requests based on the received instructions. They are also configured to provide update messages to the server upon the completion of various stages of service provision at the associated node.

Display 102 is configured to display data received from communications device 101. It comprises a port configured to receive data from communications device 101, for example an HDMI port.

Handheld controller 107 comprises a user interface and a transmitter operable to send instructions to a communications device. For example it may be configured to communicate with the communications device using Bluetooth or Infrared transmission.

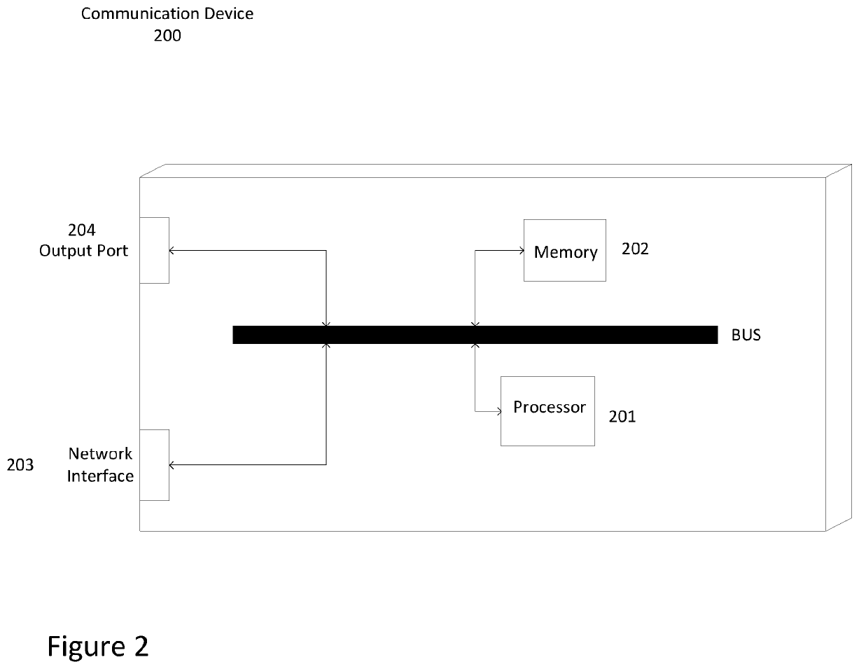

FIG. 2 illustrates a schematic view of an example of a communications device. Such a device may be used in the system of FIG. 1. The communications device 200 of FIG. 2 comprises a processor 201, memory 202, a network interface 203, and an output port. These components are configured to communicate with each other via a system bus.

Network interface 203 is configured to send and receive data packets over a short range communication interface and a wide range communication interface. It comprises a WiFi antenna configured to communicate wirelessly with other WiFi enabled devices, for example over a wireless local area network. It also comprises an Ethernet port configured to communicate over a wired network, for example a wired local area network. Network interface 203 is also operable to send and receive data over a wireless personal area network (WPAN) such as a Bluetooth network.

Output Port 204 may comprise a port for a connector for a display, such as an HDMI interface. In some embodiments it may be configured to transmit data to the display 102.

In order for the communications device 101 to communicate with the UEs, a connection between each UE and the communications device is first established. The communications device 101 broadcasts a discovery message over the wireless LAN 104 indicating that it is available to be connected to. This message may be received by any number of UEs 103 that are also connected to the wireless LAN 104. In response a UE 103 may transmit a connection message to communications device 101, confirming the connection between the communications device and the UE.

### In Operation

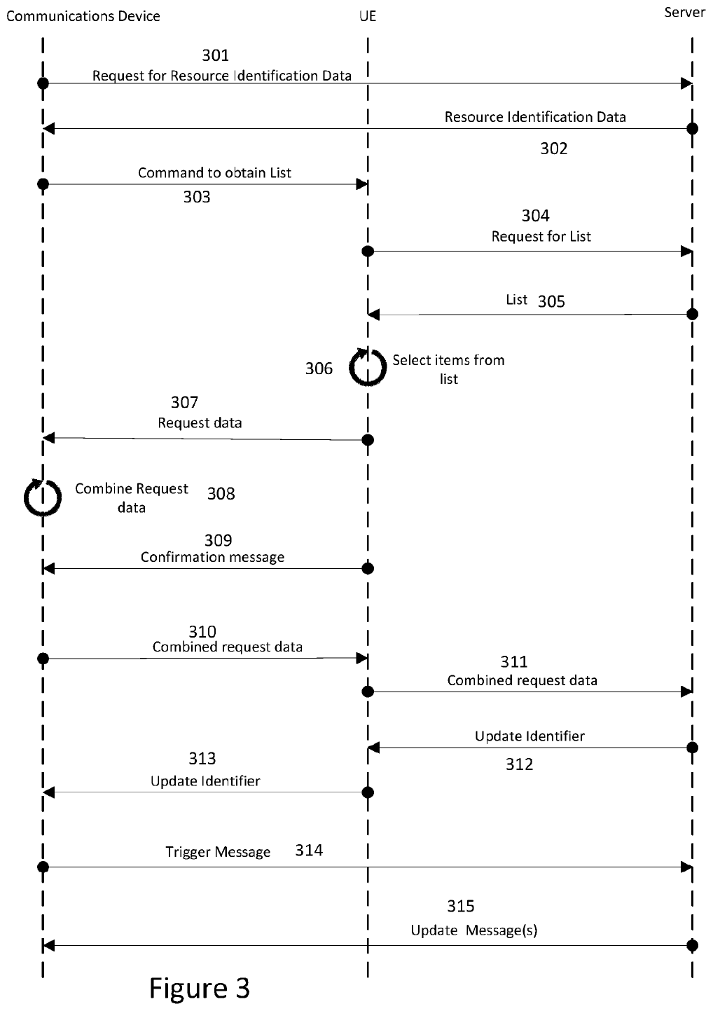

FIG. 3 shows a telecommunications timing diagram illustrating a method for operating a system such as that described above with reference to FIG. 1 and FIG. 2.

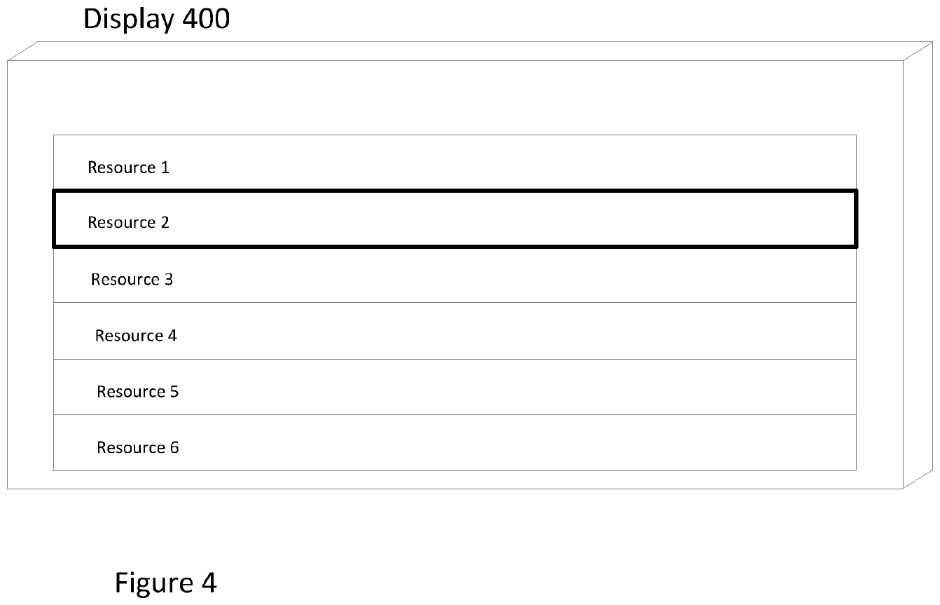

In the mode of operation illustrated in FIG. 3, the communications device 101 receives instructions from the user operating handheld controller 107, instructing the communications device to select a particular resource from a list of resources. The list is displayed to a user on the display 102 as they operate the handheld controller 107, for example as illustrated in FIG. 4. The user may scroll through the resources using the handheld controller and select one. Once a resource is selected, the communications device 101 transmits a message 301 via the WAN 105 to the server 106, containing a request for resource identification data—i.e. data used to identify the selected resource. Upon receiving the request, the server 106 transmits the requested resource identification data 302 back to the communications device 101 via the WAN 105.

The communications device transmits a command message 303 comprising the selected resource ID to the UEs. The command instructs each UE to obtain data from server 106 via the WAN 105. Each UE sends a request 304 for a list associated with the resource ID to the server 106 via the WAN 105. This triggers the server 106 to provide the list 305 to each UE in response, transmitting it via the WAN 105.

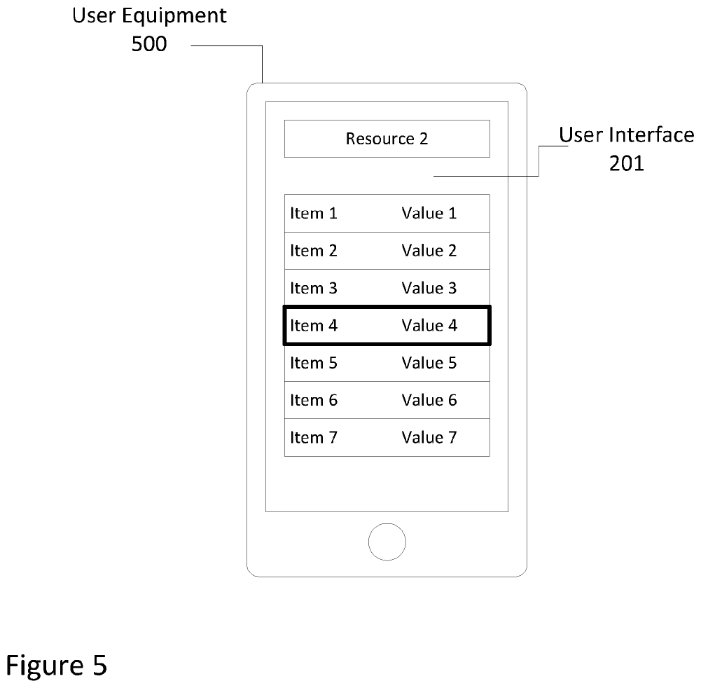

Receiving the list triggers the UE to provide a user interface to a user. The user interface is configured to enable the user to scroll through the list and select items from it 306, for example using a touch-screen. An example of a user interface comprising the list displayed to the user on a smartphone 103 is illustrated in FIG. 5.

Each time an item is selected at one of the plurality of UEs 103, request data indicating the item selected is transmitted from UE 103 to communications device 101 over LAN 104 307. Transmitted request data may also comprise at least one of: the value associated with the requested item; a type identifier indicating which of a set of item types the selected item belongs to; and a UE identifier, identifying from which UE the request data was transmitted.

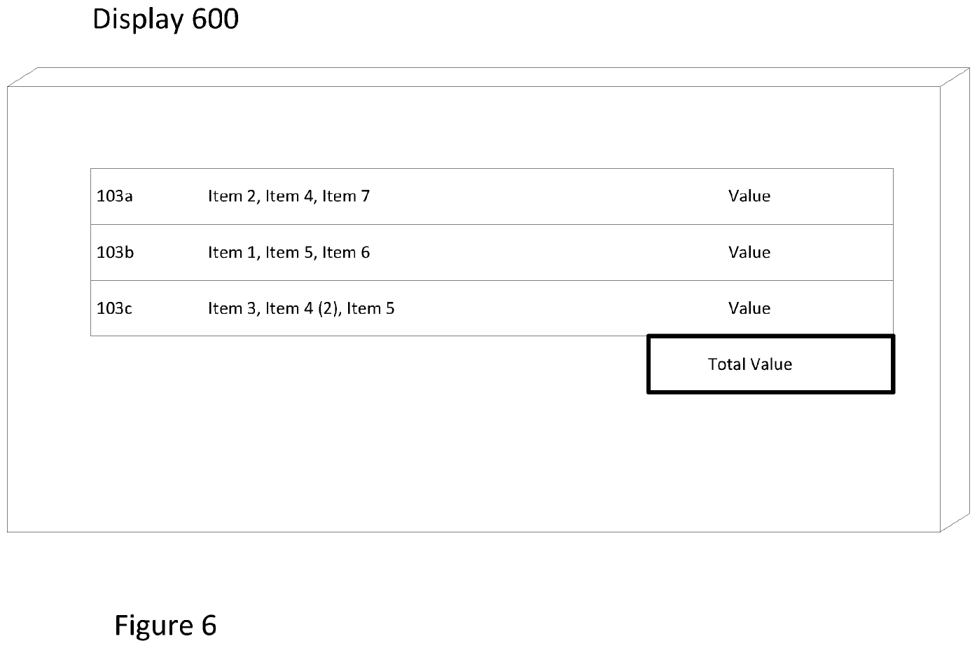

Communications device 101 adds each item of request data it receives to a list of combined request data 308. Data indicating the combined list is transmitted to display 102, such that each time request data is added to the list, the display is correspondingly updated. FIG. 6 illustrates an embodiment where the items selected at each of the UEs are displayed. In the embodiment illustrated in FIG. 6, the request data received by the communications device 101 indicating which items have been selected at each UE comprises a UE identifier which identifies the UE from which the request data was sent. The communications device, when combining the request data received from the plurality of UEs, may divide the combined request data into sets based on each item's UE identifier. The values associated with each item of request data received at the communications device 101 are summed to provide a combined value for each UE, and a total value representing the combined value of all items selected by all the UEs.

The combined list displayed on the display 102 is viewable by the users operating the UEs 103.

A completion message is transmitted from each of the UEs to the communications device to indicate that no more request data is to be transmitted from that particular UE. When the communications device 101 receives a completion message from all the connected UEs in the network, it broadcasts a confirmation request over LAN 104. The UEs 103 receive the confirmation request and displays the confirmation request to a user on its user interface. In response, one of the UEs, for example 103a, transmits a confirmation message 309 to the communications device 101. For example, the confirmation request received by the UE 103a causes the UE 103a to provide a selectable item to a user on its user interface. The user can select this item on the user interface, causing the UE to transmit the confirmation message to the communications device 101.

In response to receiving the confirmation message, communications device 101 transmits data comprising the combined request data list 310 to the UE 103a from which the confirmation message was sent. UE 103a transmits the combined request data 311 to the server 106 over the WAN.

The server 106 assigns the combined request data it receives a request identifier. The server 106 may then forward the combined request data, for example over the WAN, to the selected resource where it is processed.

The server 106, in response to receiving the combined request data, transmits an update identifier 312 comprising the request identifier to the UE 103a, which confirms receipt of the request data. The UE 103a forwards the update identifier 313 to the communications device 101. In response to receiving the update identifier, communications device 101 sends a trigger message 314 comprising the update identifier to the server 106. The trigger message comprises a command instructing the server to send update messages to communications device 101 upon completion of stages of request processing. Update messages are transmitted (315) at intervals from the server 106 to the communications device 101, with a message sent each time that a request processing step is completed at the server or selected resource.

The communications device then relays the update messages to the UEs, for example by sending them over the LAN 104. In response to receiving an update message the UEs may display content based on the message on their user interface, thus enabling a user operating the UE to remotely monitor the progress of request processing at the server or selected resource.

### Alternatives and Variations

In some embodiments, when the communications device 101 receives request data from a first UE, it transmits a notification message to the other UEs. The notification message comprises instructions to the other UEs to modify their user interface. In one example, in response to the notification message, one or more of the other UEs modifies their user interface so that the items ordered at the first UE are identified. Furthermore, in response to receiving the notification message, the other UEs may modify their user interface to identify a user associated with the first UE, and associate the list of items ordered at that UE with that user.

In some embodiments, the notification message may provide instructions to the UE to remove items from the list provided by the server, so that only a subset of items from the list are displayed to the user on the user interface. In another example the notification message may provide instructions to the UE to only request a selected section of the list from the server. In another embodiment, suggested items for users to select may be provided on the user interface of the other UEs based on the items selected at the first UE that are identified in the notification message.

In one embodiment, a notification message is transmitted from the communications device 101 to one of the plurality of UEs 103 comprising a message to be displayed at the UE's user interface. The message may instruct the user to operate the UE to send a completion message to the communications device 101.

In one mode of operation, the communications device 101 may provide a time limit to the UEs to select items from the list. For example it may receive a message from one of the plurality of UEs indicating the time limit. The communications device may provide this time limit to the plurality of UEs when transmitting the command to the UEs to obtain a list from the server. The time limit indicates the time that the UEs have between receiving the command message from the communications device, and completing selection of items from the list. In one example, if a UE has not transmitted a completion message when the time limit has been reached, a notification is sent from the communications device to the UE to provide a message to the user instructing them to send a completion message. In another embodiment, if a completion message has not been sent by the end of the time limit, one is automatically sent from the UE to the communications device and the UE is not operable to select further items from the list.

In an embodiment the communications device receives a numeric limit from a first UE, and provides an indication of the limit to the other UEs. For example the first UE may enable a first user to select the numeric limit on its user interface and transmit data indicating the selected limit to the communication device. This may trigger the communications device to transmit data indicating the selected limit to the other UEs. In one embodiment the numeric limit may be selected at the communications device by a user operating the handheld controller.

In an embodiment, the UEs receive a notification message and in response modify their user interface based on the limit and content of the notification message, for example the notification message may identify an item of the list. For example the limit displayed on the user interface of the UEs may be decremented due to item(s) being selected at a first UE. In an embodiment, the item(s) identified in the notification message may be an item selected at a first UE. The notification message received by the UEs may instruct the UEs to decrement the limit displayed on their user interfaces, for example the limit may decrement by the value of the item selected at the first UE.

In one mode of operation a UE may transmit a command to the communications device 101 instructing the communications device to remove request data from the list of combined request data.

In one mode of operation, an additional step occurs that enables the communications device 101 to control which of the plurality of UEs are operable to receive the list of combined request data. The communications device 101 stores a list of authorisation data identifying at least one of the UEs that are authorised to receive the combined request data. This data may have been provided by one of the plurality of UEs to the communications device 101 at a previous point in time. Upon receiving a first confirmation message from a UE, communications device 101 checks the list of authorisation data to confirm whether it was provided by an authorised UE. The communications device 101 only provides the combined request data to a UE if it determines that the UE is authorised. In one embodiment, in the event that the confirmation message was provided by an unauthorised UE, the communications device transmits a request to an authorised UE for additional authorisation data. This request may comprise an instruction for the UE to transmit an override message to confirm that the list of combined request data may be sent to the unauthorised UE. In another embodiment, prior to transmitting the confirmation request, the communications device may check the list of authorisation data and only transmit the confirmation request to authorised UEs.

In one embodiment, when communications device 101 receives request data from each UE, it combines the received request data into sets, wherein each set is associated with one of the UEs and each set comprises the items requested at the associated UE. In response to transmitting a confirmation request, communications device 101 may be configured to receive a plurality of confirmation messages from a plurality of UEs. Upon receipt of each confirmation message, communications device 101 provides each set of combined request data to its associated UE. In response to receiving its associated set of combined request data back from the communications device, each UE is able to transmit its request data to the server 106.

In an alternative mode of operation, the combined request data that is transmitted from a UE to the server comprises a communications device identifier, which identifies the communications device as being associated with the transmitted combined request data. This enables the server to send an update identifier directly to the communications device instead of to the UE from which the combined request data was received.

In one embodiment one of the UEs is configured to act as the handheld controller and perform the functions associated with it described above.

In some embodiments the UEs are operable to communicate directly with the server over a wide area network, rather than via the local area network. For example the UEs may communicate with the server over a mobile data network.

In some embodiments the server communicates with the UEs using a relay, for example when providing the selected list to the UEs. In this case the server transmits the list to the communications device over the WAN, which in response forwards the list to the UEs over the LAN. In other embodiments the server transmits the list to the UEs from the WAN to the LAN, bypassing the communications device.

In some examples, one or more memory elements, such as memory 202, can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The data stores described herein may comprise volatile and/or non-volatile memory for storing computer readable data and instructions.

An embodiment may provide a method that enables the controlling and/or monitoring of the provision of services, for example the delivery of goods such as food items prepared at a takeaway restaurant. For example an embodiment may comprise:
A method of monitoring the provision of a service, by operating a computer network comprising a communications device adapted to communicate over a short range communication interface with a plurality of user equipment (UE) devices and to communicate with a server over a wide area communication interface, the method comprising:
obtaining, from the server, resource identification data;
providing a command to the UEs to cause the UEs to obtain, from the server, a list associated with the resource identification data;
receiving request data from the UEs indicating items requested from the selected list;
combining the request data;
and, in response to a first confirmation message, providing the combined request data to a selected UE; and
obtaining, from the selected UE, an update identifier and sending a trigger message comprising the update identifier to the server to cause the server to send a series of update messages to the communications device for monitoring the provision of the requested service. This method may be used in combination with any one or none of the methods described or claimed herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The processors and controllers described herein, such as processor 201, (and the activities they perform) may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

Providing data from any of the components described to any other component may comprise transmitting data over any sort of data network or interface. Obtaining data from any of the components described may also comprise transmitting data over any sort of data network or interface. Obtaining may comprise accessing data held in a data storage unit of any component.

Embodiments of the disclosure provide computer program products, and computer readable media, such as tangible non-transitory media, storing instructions to program a processor to perform any one or more of the methods described herein.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit. It is suggested that any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

Other variations and modifications of the apparatus will be apparent to persons of skill in the art in the context of the present disclosure.

1. A method of operating a computer network comprising a communications device adapted to communicate over a short range communication interface with a plurality of user equipment (UE) devices and to communicate with a server over a wide area communication interface,
the method comprising:
obtaining, from the server, resource identification data;
providing a command to the UEs to cause the UEs to obtain, from the server, a list associated with the resource identification data;
receiving request data from the UEs indicating items requested from the list;
combining the request data;
and, in response to a first confirmation message, providing the combined request data to a selected UE; and
obtaining, from the selected UE, an update identifier and sending a trigger message comprising the update identifier to the server to cause the server to send a series of update messages to the communications device.

2. The method of claim 1 wherein the communications device is configured to respond to request data received from a first one of the UEs by providing a notification message to at least one other of the UEs.

3. The method of claim 2 wherein the command is configured to cause the UEs to provide a user interface based on the list, and the notification message is configured to cause the UEs to modify the user interface.

4. The method of claim 3 wherein modifying the user interface comprises at least one of:
identifying, in the user interface of a second UE, an item specified by the request data from the first one of the UEs;
identifying, in the user interface of the second UE, a user associated with the first one of the UEs;
suggesting a second item based on items identified in the notification message;
causing a display of a selected section of the list;
removing items from the list.

5. The method of claim 3 wherein the communications device comprises a display interface for controlling a display, and provides a display signal reflecting the content of the notification message.

6. The method of any of claims 3 to 5 wherein each item on each list comprises a type identifier and a numeric value, the method comprising receiving a numeric limit from a first UE, and providing an indication of the limit to the other UEs.

7. The method of claim 6 wherein the notification message causes the UEs to modify the user interface at the UEs based on the limit and content of the notification message, for example wherein the notification message identifies an item of the list.

8. The method of any preceding claim wherein the short range communication interface comprises at least one of:
a wireless local area network (WLAN) such as a WiFi network; and
a wireless personal area network (WPAN) such as a Bluetooth network.

9. The method of any preceding claim wherein the first confirmation message is received over the short range communication interface.

10. The method of any preceding claim wherein the selected UE is configured to transmit the combined request data to the server via the wide area communications interface.

11. The method of any preceding claim, wherein the communications device stores authorisation data identifying at least one of the UEs, and responding to the first confirmation message comprises checking whether the confirmation message was provided by an authorised UE.

12. The method of claim 11 comprising only providing the combined request data in the event that the confirmation message was provided by an authorised UE.

13. The method of claim 11 or 12 comprising requesting additional authorisation data in the event that the confirmation message was provided by an unauthorised UE.

14. The method of any preceding claim comprising:
providing, to a first UE, identification data identifying the other UEs;
receiving from the first UE, an identifier of a second UE.

15. The method of claim 14 comprising only transmitting the combined request data in the event that the confirmation message was provided by the second UE.

16. The method of any preceding claim comprising:
receiving, prior to obtaining resource identification data, a signal from a handheld controller; and determining, based on the received signal, which resource identification data to obtain from the server.

17. The method of any of claims 1 to 15 further comprising the steps of:
receiving, prior to obtaining resource identification data, data from each of the plurality of UEs indicating a preference for one of the plurality of lists; and
determining, based on the data received from each UE, which of a plurality of resource identification data to obtain from the server.

18. The method of any preceding claim comprising:
transmitting a connection request;
receiving, from a UE in response to the connection request, a connection confirmation message.

19. The method of any preceding claim comprising receiving, from the UEs, a message indicating that no more request data will be received from that UE.

20. The method of claim 2 wherein the notification message received by a UE causes a message to be displayed comprising instructions to transmit request data.

21. The method of any preceding claim comprising receiving, from one of the UEs, a command to remove request data received from the UE from the combined request data.

22. The method of any preceding claim wherein each item of request data has a UE identifier associated with it that indicates which of the plurality of UEs transmitted the item of request data.

23. The method of any preceding claim wherein combining the request data comprises:
determining, for each item of request data, which UE requested the item, based on its associated UE identifier.
combining the request data into sets of combined request data, wherein each set is associated to one of the UEs.

24. The method of claim 23 comprising:
providing each set of combined request data to its associated UE; wherein
each UE is configured to transmit its associated set of combined request data to the server.

25. A communications device adapted to communicate over a short range communication interface with a plurality of user equipment (UE) devices and to communicate with a server over a wide area communication interface; wherein the communications device is configured to:
obtain, from the server, resource identification data;
provide a command to the UEs to cause the UEs to obtain, from the server, a list associated with the resource identification data;
receive request data from the UEs indicating items requested from the list;
combine the request data;
and, in response to a first confirmation message, provide the combined request data to a selected UE; and
obtain, from the selected UE, an update identifier and send a trigger message comprising the update identifier to the server to cause the server to send a series of update messages to the communications device.

26. The communications device of claim 25, further configured to respond to request data received from a first one of the UEs by providing a notification message to at least one other of the UEs.

27. The communications device of claim 26 wherein the UEs are configured to provide a user interface based on the list in response to the command, and the notification message is configured to cause the UEs to modify the user interface.

28. The communications device of claim 27 wherein modifying the user interface comprises at least one of:
identifying, in the user interface of a second UE, an item specified by the request data from the first one of the UEs;
identifying, in the user interface of the second UE, a user associated with the first one of the UEs;
suggesting a second item based on items identified in the notification message;
causing a display of a selected section of the list;
removing items from the list.

29. The communications device of claim 27, wherein the communications device comprises a display interface for controlling a display, and is configured to provide a display signal reflecting the content of the notification message.

30. The communications device of any of claims 27 to 29 wherein each item on each list comprises a type identifier and a numeric value, wherein the communications device is further configured to receive a numeric limit from a first UE, and provide an indication of the limit to the other UEs.

31. The communications device of claim 30 wherein the UEs are configured to modify their user interface in response to the notification message, based on the limit and content of the notification message, for example wherein the notification message identifies an item of the list.

32. The communications device of any of claims 25 to 31 wherein the short range communication interface comprises at least one of:
a wireless local area network (WLAN) such as a WiFi network; and
a wireless personal area network (WPAN) such as a Bluetooth network.

33. The communications device of any of claims 25 to 32 further configured to receive the first confirmation message over the short range communication interface.

34. The communications device of any of claims 25 to 33 wherein the selected UE is configured to transmit the combined request data to the server via the wide area communications interface.

35. The communications device of any of claims 25 to 34, further configured to store authorisation data identifying at least one of the UEs, and is configured to respond to the first confirmation message by checking whether the confirmation message was provided by an authorised UE.

36. The communications device of claim 35 further configured to only provide the combined request data in the event that the confirmation message was provided by an authorised UE.

37. The communications device of claim 35 or 36 further configured to request additional authorisation data in the event that the confirmation message was provided by an unauthorised UE.

38. The communications device of any of claims 25 to 37 further configured to:
provide, to a first UE, identification data identifying the other UEs;
receive from the first UE, an identifier of a second UE.

39. The communications device of claim 38 further configured to only transmit the combined request data in the event that the confirmation message was provided by the second UE.

40. The communications device of any of claims 25 to 39 further configured to:
receive, prior to obtaining resource identification data, a signal from a handheld controller; and
determine, based on the received signal, which resource identification data to obtain from the server.

41. The communications device of any of claims 25 to 39, further configured to:
receive, prior to obtaining resource identification data, data from each of the plurality of UEs indicating a preference for one of the plurality of lists; and
determine, based on the data received from each UE, which of a plurality of resource identification data to obtain from the server.

42. The communications device of any of claims 25 to 41, further configured to:
transmit a connection request;
receive, from a UE in response to the connection request, a connection confirmation message.

43. The communications device of any preceding claim further configured to receive, from the UEs, a message indicating that no more request data will be received from that UE.

44. The communications device of claim 26 wherein the UE is configured to display a message comprising instructions to transmit request data in response to receiving a notification message.

45. The communications device of any of claims 25 to 44 further configured to receive, from one of the UEs, a command to remove request data received from the UE from the combined request data.

46. The communications device of any of claims 25 to 45 wherein each item of request data has a UE identifier associated with it that indicates which of the plurality of UEs transmitted the item of request data.

47. The communications device of any of claims 25 to 46 wherein combining the request data comprises:
determining, for each item of request data, which UE requested the item, based on its associated UE identifier.
combining the request data into sets of combined request data, wherein each set is associated to one of the UEs.

48. The communications device of claim 47 further configured to:
provide each set of combined request data to its associated UE; and wherein
each UE is configured to transmit its associated set of combined request data to the server.

49. The communications device of any of claims 25 to 48 wherein the request data comprises a request for the provision of a service.

50. The communications device of claim 49 wherein the update messages comprise an indication of the progress of the provision of the service.

51. The method of any of claims 1 to 24 wherein the request data comprises a request for the provision of a service.

52. The method of claim 51 wherein the update messages comprise an indication of the progress of the provision of the service.

53. A computer apparatus configured to perform the method of any of claims 1 to 24.

54. A computer program product comprising program instructions configured to program a processor to perform the method of any of claims 1 to 24.
